(19) United States
(12) Patent Application Publication
(10) Pub. No.: US 2018/0369767 A1
(43) Pub. Date: Dec. 27, 2018

(54) DEVICE AND METHOD FOR CARRYING OUT A CONTINUOUS EMULSION OF TWO IMMISCIBLE LIQUIDS

(71) Applicants: UNIVERSITÉ DE NANTES, Nantes (FR); CENTRE NATIONAL DE LA RECHERCHE SCIENTIFIQUE -CNRS, Paris (FR)

(72) Inventors: Jérôme BELLETTRE, Nantes (FR); Arab BELKADI, Tizi Ouzou (DZ); Agnès MONTILLET, Saint-Nazaire (FR)

(21) Appl. No.: 16/063,463

(22) PCT Filed: Dec. 15, 2016
(86) PCT No.: PCT/FR2016/053458

§ 371 Date: Jun. 18, 2018

(30) Foreign Application Priority Data
Dec. 17, 2015 (FR) 1562682

(51) Int. Cl. B01F 13/00; B01F 3/08; B01F 5/02; B01F 5/06

(52) U.S. Cl. CPC B01F 13/0061; B01F 3/0807; B01F 5/0653; B01F 5/0648; B01F 5/0651; B01F 5/0256

(57) ABSTRACT

Some embodiments relate to a device for performing continuous emulsion of two immiscible fluids. The device includes: a first microsystem including at least two micro-channels for intake of each fluid, of different respective cross sections S1 and S2, which are offset and face each other along a central intake axis A; at least two micro-channels for output of the emulsion from the device once the emulsion is formed; and an area where the intake and output micro-channels intersect, the area being capable of generating an interface between the fluids and forming a pre-emulsion flowing in the output micro-channels until the emulsion is complete. The device also includes at least one singularity capable of destabilizing the interfaces between the fluids in the pre-emulsion.

### CROSS REFERENCE TO RELATED APPLICATIONS

This application is a national phase filing under 35 C.F.R. § 371 of and claims priority to PCT Patent Application No. PCT/FR2016/053458, filed on Dec. 15, 2016, which claims the priority benefit under 35 U.S.C. § 119 of French Patent Application No. 1562682, filed on Dec. 17, 2015, the contents of each of which are hereby incorporated in their entireties by reference.

### BACKGROUND

Some embodiments are directed to micro-fluidics, and in particular, to devices and methods for the continuous emulsification of immiscible fluids, in particular in order to carry out emulsions of the water-in-oil (W/O) type intended for immediate use and calling into play flow rates compatible with industrial applications.

More particularly, some embodiments relate to the continuous emulsion of a percentage of substantially aqueous fluid (less than or equal to 20% by volume of the final emulsion formed) in a lipid fluid (for example a recovered vegetable oil or heavy fuel oil, or an animal fat), in order to form in-situ an emulsion for the purpose of the direct combustion thereof in a boiler, a furnace, a turbine or an engine.

### SUMMARY

Some embodiments provide an emulsification system that is especially dedicated to the carrying out of continuous emulsions of two immiscible liquids, and in particular emulsions of the water-in-oil (W/O) type.

The applications targeted by these embodiments relate to the field of energy conversion, such as turbines, boilers, furnaces or internal combustion engines in general. Work has shown that the presence of a small fraction of finely emulsified water (droplets of about 5 to 10 μm) in the liquid fuel makes it possible to lower the combustion temperature and as such decrease the emissions of polluting gases and of particles resulting from poor combustion. The continuous phase can be of a diverse nature such as conventional diesel, heavy fuel oil or lipid waste (used vegetable oils, animal fats).

The constraints linked to the applications under consideration are numerous, whether in terms of the nature of the fluids to be emulsified, the volume ratio of the fluids in the emulsion, or the need to design a compact method that makes it possible to process the flows that may be required for the operation of internal combustion engines.

Generally, the devices operate discontinuously (for example tanks in continuous or “batch” mode) are currently favoured. They are based on the use of suitable agitation blades (of the rotor-stator type for example) and are relatively energy-hungry. The stability over time of these emulsions is, in such devices, generally provided by adding surfactants.

As this entails producing an emulsion continuously, those of ordinary skill in the art know various systems that operate in continuous mode, such as static mixers (for example those of the commercial name SMX SULZER), membranes, high-pressure nozzles, and micro-channels. However, membranes have the disadvantage of not being able to process substantial flow rates (i.e. of about a few μl/h to a few ml/h). Moreover, static mixers do not make it possible to obtain very fine granulometries, unless models that have very small hydraulic diameters are used.

The research in the field of micro-fluidics has been very active for two decades now and shows in particular an interest in the development of methods of continuous emulsification^{[1], [2]}. A substantial number of studies are known to those of ordinary skill in the art that treat methods of emulsification substantially applied to mixtures of the oil in water type (O/W)^{[3], [4]}. This type of dispersion is considered to be less demanding in emulsification energy, this due to the use of an aqueous phase (low viscosity) as continuous phase. Undeniably, the water in oil emulsification (W/O) which is more particularly targeted in some embodiments due to the applications targeted may require an optimisation from an energy standpoint for two main reasons:
a continuous phase of which the viscosity represents 50 to 70 times that of water, and
the range of capillary numbers investigated, which is about 1000 times greater than that published in scientific literature on the subject^{[1], [5], [6], [7]}.

With regards more particularly to the continuous emulsification methods of two immiscible fluids, the devices known to those of ordinary skill in the art are micro-mixers with streams with confined impinging. A first study covered the use of impinging streams for the purpose of carrying out a liquid-liquid dispersion of immiscible fluids^{[8], [9]}. This work is based on the principle of emulsification by the impact of two sprayed streams (or “sprays”). These streams are produced by two injectors arranged facing each other inside the same chamber^{[8], [9]}.

In what follows, we find the use of impinging streams in confined systems based on the use of micro-channels with high fluid delivery speeds^{[10], [11]}.

The first studies conducted on the subject concerned the mixture of miscible fluids. The results obtained then encouraged those of ordinary skill in the art to take interest in splitting immiscible fluids, here sunflower oil and water in order to form water-in-oil emulsions (W/O), while still keeping this configuration of the flow of impinging streams confined in a micro-channel^{[12], [13]}.

Then, based on these first studies, the applicant realised a microsystem for a continuous emulsification device, which is shown in FIG. 1. Such an emulsification device 1 includes a microsystem 2 provided with two micro-channels 23, 24 for the intake of each fluid in the device that face each other along a central intake axis A, and also two micro-channels 25, 26 for the output outside of the device 1 of the emulsion once formed. The inlet 23, 24 and output 25, 26 micro-channels having an enlarged section of passage in relation to the micro-channels of the device according to some embodiments^{[14]}. In a first step, the micro-channels of the micro-system shown in FIG. 3, were machined in such a way as to have a square section of 600 μm on the side. Then, with a concern for reducing the volume fraction of the water (ϕₑ) and to generate a swirl that favours the splitting of the filaments or of the drops of the dispersed phase, the section of the water intake channel 23 was reduced to 300 μm by 300 μm, with the other channels retaining an intake section of 600 μm by 600 μm, as shown in the lateral perspective representation of the microsystem of FIG. 2. Such a micro-system has remarkable aptitudes for continuous emulsification. In the output micro-channels 25, 26, during the formation of the emulsion, it is observed that a swirl structure is formed at the centre of the microsystem, in the intersection area 27 of the microsystem where the input micro-channels 23, 24 and those of the output 25, 26 intersect. This swirl structure includes an entanglement of filaments and of water droplets surrounded with sunflower oil. In particular, FIGS. 3a and 3b are photographs showing a flow structure of the dispersed phase flowing in the micro-channels of the micro-system shown in FIGS. 1 and 2. FIGS. 3a and 3b show in particular that this flow structure is complex and has a deformed water-oil interface, i.e. with the appearance of irregular forms on the surface of this winding. The latter is indeed driven by a combination of two movements: a movement of rotation, as explained in FIG. 3d, superimposed on a movement of advection (transport), simultaneously in the direction of the two output micro-channels of the micro-system. In such a flow configuration an increase in the flow rate of the dispersed phase accelerates the rotation (accentuating the centrifugal force) and the advection to the outlets.

Such a device including the micro-system shown in FIGS. 1 to 3d makes it possible to continuously carry out an emulsion, wherein the droplets of the dispersed phase have an average dispersion diameter (d₁₀) of 10 μm with a continuous phase containing 13% by volume of Butanol and an average diameter (d₁₀) of 30 μm with a pure continuous phase (sunflower oil) without any additive. In the range of the flow rates investigated, the method of emulsification implemented with such a device consumes 1‰ of the inferior calorific power (ICP) of the liquid fuel produced^{[5]}.

However, such a device has the disadvantage that the filament formed in the output micro-channels is not split enough, which does not allow for its immediate use as fuel in internal combustion engines, turbines, boilers and furnaces.

Some embodiments therefore address or overcome all or a portion of the disadvantages of related art, by the setting in place in the device of at least one singularity able to destabilise the interfaces between the two liquids and as such further split the filament formed in the output micro-channels.

More particularly, some embodiments are directed to a device for carrying out a continuous emulsion of two immiscible fluids, the device including:
at least one first microsystem (for example made from polymethyl methacrylate, in particular the PMMA marketed under the registered trademark PLEXIGLAS®) or from metal, and more advantageously or preferably made from stainless steel or from aluminium), the first microsystem including:
   at least two micro-channels for the intake of each fluid into the device, the micro-channels, with respective sections S1 and S2 different from S1, facing each other along a central intake axis A and having an offset, linked to their difference in section,
   at least two micro-channels for the output from the device of the emulsion once formed, and
   an intersection area wherein the intake and output micro-channels intersect, the intersection area being able to generate an interface between the fluids, and as such forming a pre-emulsion intended to flow in the output micro-channels until the completion of the forming of the emulsion.

The first microsystem further includes at least one singularity capable of destabilizing the interfaces between the fluids in the pre-emulsion.

The term immiscible fluids, in terms of some embodiments, means a hydrophilic liquid and a hydrophobic liquid.

With regards to the nature of the fluids flowing in the device according to some embodiments, it is possible in particular to use a hydrophilic fluid (more advantageously or preferably aqueous) and a hydrophobic fluid (advantageously or preferably a lipid or hydrocarbon fluid).

The term microsystem, in terms of some embodiments, means a system with millimetric or submillimetric dimensions, including an intersection formed by channels of submillimetric dimensions.

The term micro-channels, in terms of some embodiments, means channels with a submillimetric hydraulic diameter, i.e. less than a millimetre.

In the microsystem of the device according to some embodiments, at least two intake micro-channels with respective difference sections S1 and S2 face each other along a central intake axis A and having an offset, linked to their difference in section, in a direction different from the central intake axis. However, these channels are not necessarily arranged symmetrically in relation to this central intake axis (as is shown in FIG. 3d). Indeed, the intake channels are offset in depth in the microsystem, as such forming a step.

In addition to the intake micro-channels, the microsystem of the device according to some embodiments furthermore includes at least two micro-channels for the output from the device of the emulsion once formed, and an intersection area wherein the intake and output micro-channels intersect.

Advantageously, the first microsystem can include a supply and collection system, and a part wherein the micro-channels and the singularity or singularities are etched.

Advantageously, the output micro-channels can be arranged in the microsystem of the device according to some embodiments, in such a way as to face each other along a central output axis that is different from the central intake axis, and more advantageously or preferably symmetrically, in relation to the central intake axis. More advantageously or preferably, the output micro-channels can be arranged perpendicularly to the intake axis by facing each other along the central output axis.

The device according to some embodiments further includes at least one singularity able to destabilise the interfaces between the two liquids in the pre-emulsion (or offset impinging stream), with these interfaces being created in the intersection area of the microsystem and being completed by the singularity or singularities. These singularities are etched within output micro-channels.

The intersection area of the microsystem according to some embodiments allows for the propulsion and the impact of the two fluids to be emulsified at relative substantial speeds. From these impacts, a pre-emulsion of the two fluids in the intersection area is created. This pre-emulsion has the form of a swirl structure, including an entanglement of filaments and of droplets of fluid of the dispersed phase surrounded by fluid of the continuous phase. This structure starts to be split in the intersection area, in order to reach an emulsion at the outlet of the output channels. The slitting is continued and is refined during the passage of the pre-emulsion in the singularity or singularities (in particular the bend or bends). These speeds are of about 1 to 3 metres per second, which is largely above the fluid speeds usually observed in micro-channels.

The device according to some embodiments is therefore particular suited to emulsifying a fluid with a low viscosity flowing in an intake micro-channel (for example water), in a fluid with a much higher viscosity (for example a lipid or hydrocarbon fluid) flowing in a second intake micro-channel. Furthermore, the device according to some embodiments has the advantage of being compact and offers the possibility of continuously producing and on demand an emulsion in-situ by overcoming the use of surfactant. This has a considerable interest in the case of an emulsion intended to be used as a fuel, given that the use of surfactant in a fuel worsens the carbon and economic content of the method.

According to a first advantageous embodiment, the singularity can be a bend formed in each output micro-channel of the microsystem.

In this first embodiment, the device according to some embodiments can include two to six bends formed in each output micro-channel of the microsystem.

According to a second advantageous embodiment, the singularity can be an abrupt enlargement or a narrowing formed in each output micro-channel of the microsystem.

According to a third embodiment, the device according to some embodiments can furthermore include a second microsystem in series or in parallel including:
at least two micro-channels for the intake into the device of each fluid, facing each other along a central intake axis,
at least two micro-channels for the output from the device of the emulsion formed according to some embodiments.

Advantageously or preferably, in this third embodiment, it is possible to use as a second microsystem, a microsystem identical to the first microsystem.

Advantageously, regardless of the embodiment, the intake and output micro-channels have a square or rectangular section S1, S2, and of which the hydraulic diameter can advantageously be between 100 and 800 micrometres.

Some embodiments are directed to a method for carrying out a continuous emulsion of two immiscible liquids implementing the device disclosed above, the method including:
1) the arrival of each fluid in the intake micro-channels of the microsystem;
2) the frontal collision (or impinging stream) of the fluids at the intersection of the intake and output micro-channels, in such a way as to generate an interface between the two liquids forming a pre-emulsion (or filament),
3) intake of the pre-emulsion into the output channels, and
4) output of the microsystem via the output channels of the finalised emulsion including a continuous phase and a dispersed phase.

The flow rate of the continuous phase is between 8.3.10⁻⁷ m³/s to 20.10⁻⁷ m³/s (i.e. between 50 and 200 ml/min), and the fluid of the dispersed phase represents between 3 and 20% by volume of the continuous phase.

of the method further includes splitting of the pre-emulsion between the steps 3 and 4, in order to obtain an emulsion with an average diameter of the drops of the dispersed phase between 5 and 20 micrometres.

Advantageously, the fluid of the dispersed phase represents between 5 and 10% by volume of the continuous phase.

Advantageously, the flow rate of the continuous phase is between 8.3.10⁻⁷ m³/s to 12.10⁻⁷ m³/s (i.e. between 50 and 120 ml/min).

Advantageously, the fluids to be emulsified include a hydrophilic fluid, which is advantageously or preferably an aqueous phase, and a hydrophobic fluid, advantageously or preferably a lipid or hydrocarbon fluid.

Advantageously or preferably, the hydrophilic fluid is a salt-free aqueous phase and the lipid or hydrocarbon fluid is free of surfactant.

Some embodiments are directed to using the emulsion able to be obtained by the method disclosed above as a fuel for internal combustion engines, turbines, furnaces and boilers, if the hydrophilic fluid is a salt-free aqueous phase and the lipid or hydrocarbon fluid is free of surfactant.

As such, the device and the method according to some embodiments therefore operate on principles for the emulsification of two non-miscible fluids, which are different from those known in related art, for the main application targeted: realisation of emulsified fuel, in particular intended to be used in internal combustion engines. Thanks to the device and to the method disclosed above, a better combustion of the fuel is obtained by a micro-explosion effect. The microsystems of the device disclosed above associate an impinging stream (frontal collision of the intake fluids intended to be emulsified) generated by the intersection of the microsystem and the offset intake channels in depth (in such a way as to form a step) and the singularity or singularities (for example the bends in the output channels). The straight length of the channels can be dimensioned with the objective of reducing or minimising drops in pressure in the microsystem. Moreover, the various geometries of the singularities that can be implemented in the device disclosed above are used to favour the flow effects favourable to the fluid/fluid splitting: in particular, the formation of a winding on the step (offset in the depth between the intake channels) increases the stresses undergone by the pre-emulsion. The number and position of the singularity or singularities in the output micro-channels make it possible to optimise the splitting. Thanks to these various mechanisms, it is possible to produce a continuous emulsion without additives (in particular surfactant).

### BRIEF DESCRIPTION OF THE FIGURES

Other advantages and particularities of some embodiments shall result from the following description, provided as a non-limiting example and in reference to the following examples and to the corresponding accompanying figures:

FIG. 1 shows a perspective lateral view of a microsystem of the device according to related art;

FIG. 2 also shows a perspective lateral view of the intersection area of the microsystem shown in FIG. 1;

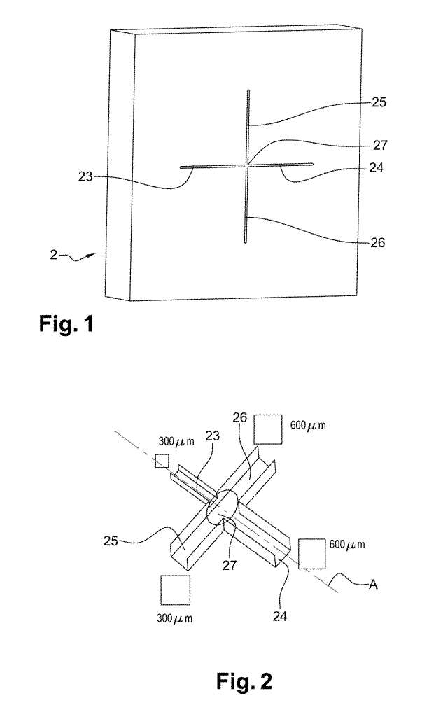

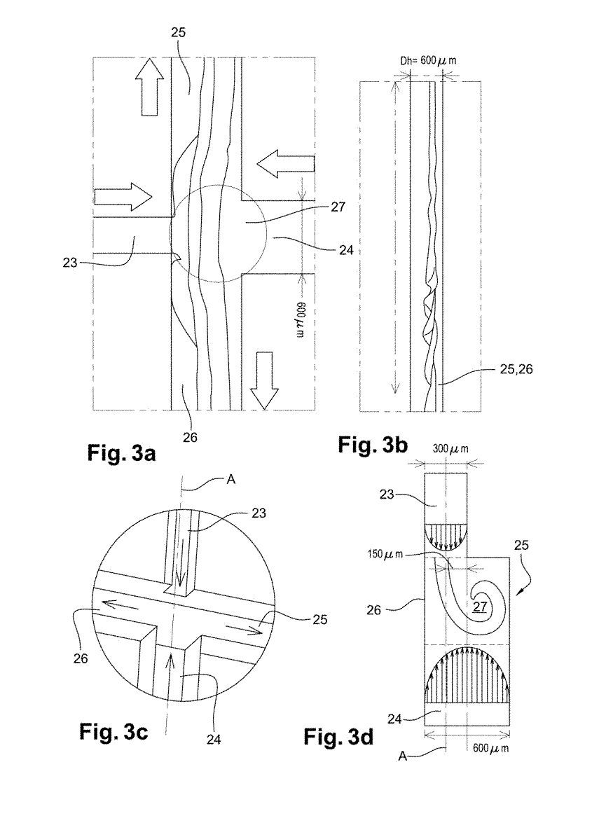

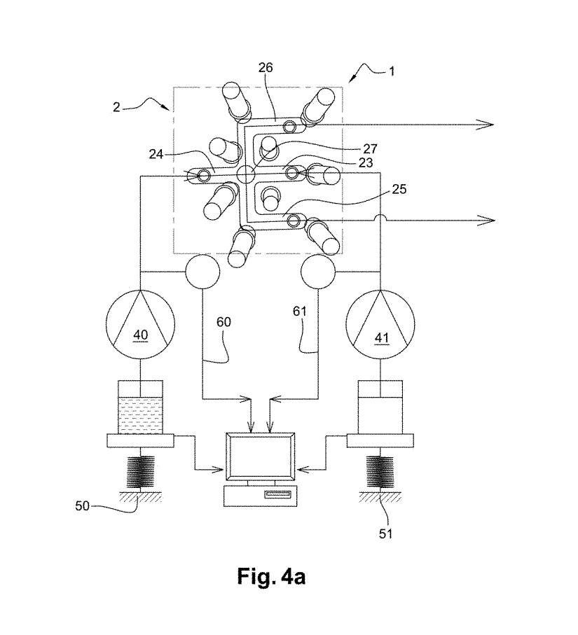

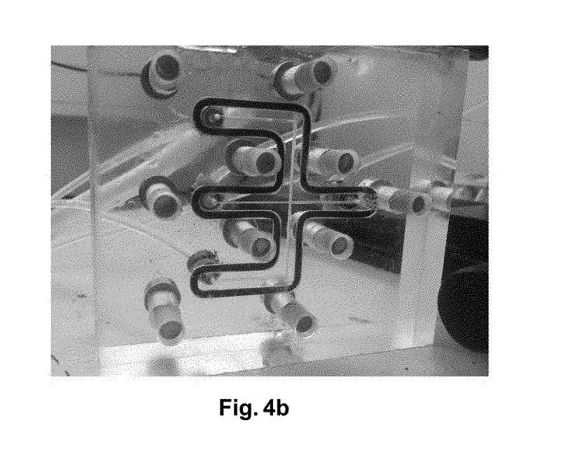

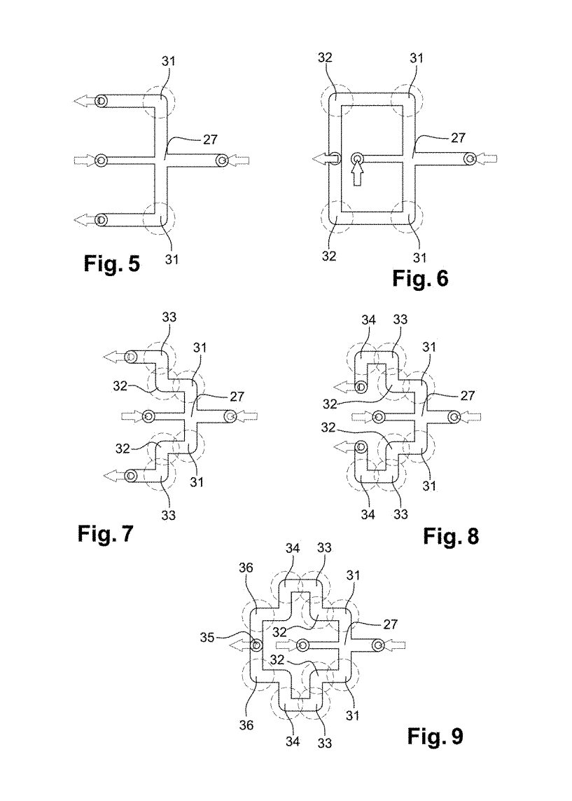

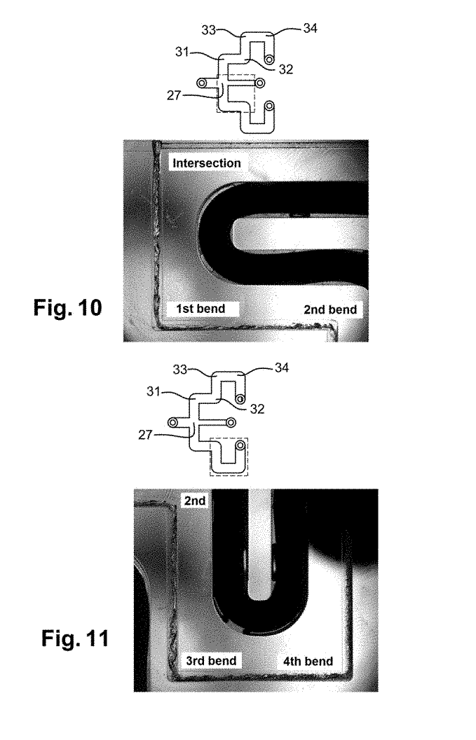

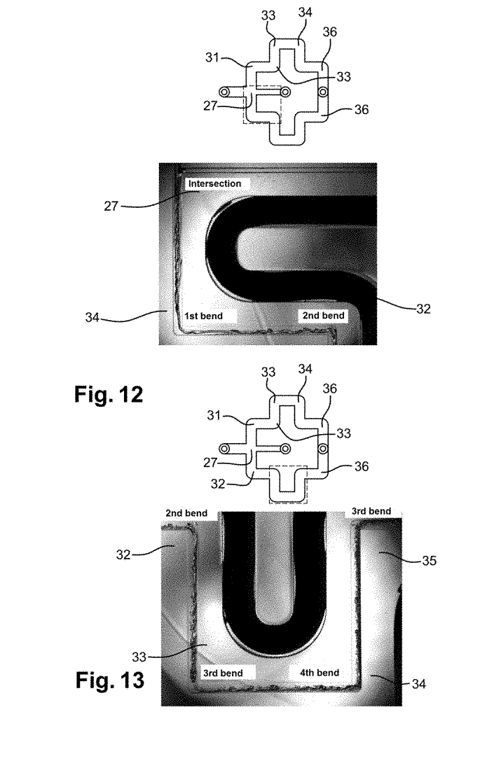

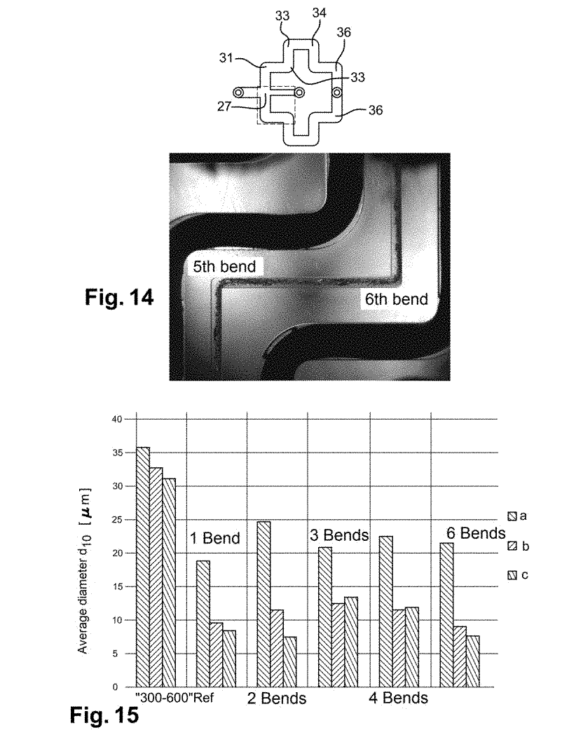

FIG. 3a shows a visualisation of a W/O pre-emulsion flowing into an output micro-channel of the microsystem shown in FIGS. 1 and 2 under the following flow conditions:
flow rate of water in an intake micro-channel 23 Qₑ=9.7 mL/min, and
flow rate of oil in the other intake micro-channel 24 Qₕ=74.0 mL/min;

FIG. 3b shows a view at a given frequency of the pre-emulsion W/O flowing in the same micro-channel as the one shown in FIG. 3, but under different flow conditions:
flow rate of water in an intake micro-channel 23 Qₑ=10.0 mL/min, and
flow rate of oil in the other intake micro-channel 24 Qₕ=59.5 mL/min;

FIG. 3c also shows a perspective lateral view of the intersection area shown in FIG. 1, showing the arrival of the water in an intake channel 23 and the arrival of the oil in the other intake channel 24;

FIG. 3d diagrammatically shows the frontal collision (or impinged stream) of the water and of the oil in the intersection area of the microsystem shown in FIG. 3c;

FIG. 4 is a block diagram of an emulsification bench including a first example of a device according to some embodiments, wherein each output micro-channel 25, 26 of the microsystem 2 includes a bend 31 (therefore two bends per microsystem); FIG. 4b is a photograph of a microsystem according to some embodiments

FIG. 5 is a block diagram of the intersection area 27 of the microsystem shown in FIG. 4b including 2 bends;

FIG. 6 is also a block diagram of the intersection area 27 of a microsystem of a second example of the device according to some embodiments, wherein each output micro-channel 25, 26 of the microsystem includes two bends (therefore four bends per microsystem);

FIG. 7 is also a block diagram of the intersection area 27 of a microsystem of a third example of the device according to some embodiments, wherein each output micro-channel 25, 26 of the microsystem includes three bends (therefore six bends per microsystem);

FIG. 8 is also a block diagram of the intersection area 27 of a microsystem of a fourth example of the device according to some embodiments, wherein each output micro-channel 25, 26 of the microsystem includes four bends (therefore eight bends per microsystem);

FIG. 9 is also a block diagram of the intersection area 27 of a microsystem of a fifth example of the device according to some embodiments, wherein each output micro-channel 25, 26 of the microsystem includes six bends (therefore twelve bends per microsystem)

FIG. 10 shows a photograph, on the first and second bends of an output micro-channel, of a W/O pre-emulsion flowing into an output micro-channel of the micro-system shown in FIG. 8 (microsystem with a total of eight bends) with the following flow conditions:
flow rate of water in an intake micro-channel 23 Qₑ=14.9 mL/min, and
flow rate of oil in the other intake micro-channel 24 Qₕ=62.5 mL/min;

FIG. 11 shows a photograph, on the second, third and fourth bends of an output micro-channel, of a W/O pre-emulsion flowing into an output micro-channel of the micro-system shown in FIG. 8 (microsystem with a total of eight bends) in the same flow conditions as for the FIG. 10;

FIG. 12 shows a photograph, on the first and second bends, of a W/O pre-emulsion flowing into an output micro-channel of the micro-system shown in FIG. 9 (microsystem with six bends per micro-channel and 12 bends in total) with the following flow conditions:
flow rate of water in an intake micro-channel 23 Qₑ=15.0 mL/min, and
flow rate of oil in the other intake micro-channel 24 Qₕ=62.35 mL/min;

FIG. 13 shows a photograph, on the fifth and sixth bends, of a W/O pre-emulsion flowing into an output micro-channel of the microsystem shown in FIG. 9 (microsystem with twelve bends in total) in the same flow conditions as for the FIG. 12;

FIG. 14 shows a photograph, on the fifth and sixth bends, of a W/O pre-emulsion flowing into an output micro-channel of the micro-system shown in FIG. 9 (microsystem with twelve bends) in the same flow conditions as for the FIG. 12;

FIG. 15 is a bar chart showing the influence of the flow rate of the dispersed phase and of the number of bends over the average diameter d₁₀ of the droplets in the emulsion obtained.

### DETAILED DESCRIPTION OF EXEMPLARY EMBODIMENTS

FIGS. 1 to 3d are commented in the description of related art.

FIG. 4 is a block diagram of an emulsification bench 1 including a first example of a device 1 according to some embodiments, wherein each output micro-channel 25, 26 of the microsystem 2 includes a bend 31 (therefore two bends per microsystem 2).

The microsystem 2 of the device according to some embodiments is differentiated from the one shown in FIGS. 1 to 3d by the presence of a bend 31 in each output micro-channel 25, 26.

This emulsification bench 1 was developed and used (cf. example hereinafter) to test in emulsification conditions corresponding to the targeted applications (properties of the fluids and flow rates called into play) the microsystems according to some embodiments such as shown in FIGS. 5 to 14.

This emulsification bench forms a device 1 according to some embodiments, wherein the microsystem 2 includes two plates made of transparent PMMA (for example of PMMA marketed under the registered trademark PLEXIGLAS®) in order to facilitate the optical investigations. The micro-channels are etched using a micro-mill on one of these plates.

The microsystem 2 of the emulsification bench shown in FIG. 4 corresponds to the one shown in FIG. 5, including two bends (one on each output micro-channel 25, 26). But, the configurations of microsystems according to some embodiments such as shown in FIGS. 6 and 10 (4 bends in total), 7 (6 bends in total), 8, 10 and 11 (8 bends in total) and 9, and 12 to 14 (12 bends in total) were also tested. These configurations of microsystems 2 according to some embodiments represent significantly improved versions of the reference configuration shown in FIGS. 1 to 3d.

The emulsification bench 1 of FIG. 4 is moreover provided with two double-piston displacement pumps 40, 41 (for example those marketed by ARMEN under the commercial name APF-100). The maximum pressure and the maximum working flow rate of these pumps 40, 41 are respectively 25 bars and 100 ml/min (maximum flow rate in the case of use of water). In order to allow for a more accurate measurement of the flow rate, the bench 1 is provided with two scales 50, 51 (for example scales of the registered trademark Sartorius® (model MSE2203) that allow for an acquisition of the mass weighed over time of which the precision is ±10⁻³ g. The measurement of the pressure is provided by two compact pressure transmitters 60, 61 (for example marketed under the registered trademark Gems®, model 3100). The measurement range of the pressure sensor is 0-25 bars for a precision of ±0.25% on full scale. These pressure sensors 60, 61 are connected to the water and oil circuit between the pump and the inlet of the micro-channel. The pressure sensors 60, 61 measure the static pressure for each one of the two mixed liquids. All of the connections between the pumps and the micro-channels are established using tubes made from Fluoropolymer (FEP) of which the dimensions are as follows: an inner diameter (ID) of 1.55 mm and an outer diameter (OD) of 3.125 mm.

The following example shows some embodiments without however limiting the scope thereof.

### EXAMPLE

The emulsification bench described hereinabove and shown in FIG. 4 was used to test in different flow conditions close to the targeted applications (for the properties of the fluids and the flow rates called into play) the microsystems according to some embodiments such as shown in FIGS. 5 to 14, by comparing them to the microsystem without bends such as shown in FIGS. 1 to 3d.

### Fluids Used

During these tests, using the emulsification bench shown in FIG. 4 and in accordance with the method according to some embodiments, an aqueous phase (dispersed phase) and a lipid phase (continuous phase) was continuously emulsified.

Water was used as aqueous phase in small quantities, not exceeding 20% by volume, compared to sunflower oil which represents the continuous phase therefore the major phase. Sunflower oil was chosen in order to operate according to the principle of a cold model. The viscosity of this oil, at ambient temperature, corresponds to the temperature of heavy fuel oil preheated in an engine. The characteristics of the various fluids used are gathered together in the table 1 hereinafter.

TABLE 1

| | | Water | Sunflower oil |
|---|---|---|---|
| Properties of the fluids tested | | at 25° C. | at 25° C. |
| Surface tension in air | γ | 73.5 | 33.67 |
| Inter-facial tension in water | γ_{e/h} [mN/m] | — | 27.6 |
| Dynamic viscosity | μ [mPa · s] | 0.91 | 52.2 |
| Density | ρ [g/l] | 998 | 865 |

All of the emulsification tests were conducted at a temperature of 25° C. Due to the friction effects of the fluids, the emulsion at the outlet of the emulsification circuit experienced heating of about +5° C. in relation to the intake temperature.

For all of the tests carried out, the flow rate Qₕ of the oily phase in an intake micro-channel was set to about 60 ml/min, for three flow rates of water Qₑ tested (about 5 ml/min, 10 ml/min and 15 ml/min).

### Emulsification Results

The properties of the pre-emulsion formed after the impact (frontal collision) are studied at the intersection between the stream of water and that of the sunflower oil in the intersection area 27 of the microsystem 2 (via high-frequency view of the flow in the output micro-channels), as well as via measurement of the diameter d₁₀ of the droplets formed in the emulsion at the outlet of the micro-channels (bar chart shown in FIG. 15).

### High-Frequency View of the Flows

Entailing flows of the two-phase type characterised by substantial flow speeds and implemented in complex geometries, it cannot be considered to carry out numerical simulations.

The views at high frequency are therefore indispensable for following the splitting of the fluids in the bend or bends present in the emulsion channel. The objective of these views makes it possible to show the favoured located of the splitting, and also the areas where the coalescence of the droplets can possibly be produced.

FIGS. 10 and 11 show the transformations that are produced on the filament in the microsystem with 4 bends per output micro-channel (eight bends in total), while FIGS. 12 to 14 concern the microsystem with 6 bends per micro-channel (12 bends in total: cf. also FIG. 9).

### Bar Graph (FIG. 15)

FIG. 15 is a bar chart showing the influence of the flow rate of the dispersed phase and of the number of bends on the average diameter d₁₀ of the droplets in the emulsion obtained, obtained by calculating the arithmetical average of the diameters of the droplets (d₁₀) for the sample analysed (d₁₀=Σᵢdᵢ/nᵢ).

This bar chart makes it possible to judge the pertinence of adding one or several additional bends. The letters a, b and c represent the three ranges of flow rates of the dispersed phase. The data shows the interest in placing two bends in series and in provoking two impacts in the microsystem (configuration shown in FIG. 6) when a substantial flow rate of water is used (range “c” of the water flow rate of about 15 ml/min). The comparison of the average diameters d₁₀ shows that the reference system without bend is not as suited for the water-in-oil dispersion (see the bar chart of FIG. 15).

The purpose of the presence of the bends is to generate, in addition to the viscous forces of which the role is preponderant on the splitting^{[15]}, with additional stresses used to fragment the filament of water initially formed (see FIGS. 3a and 3b) at the intersection at the time of the impact between the stream of water and the stream of oil. The various versions were designed so as to experimentally study the effect of an abrupt change in direction in a single or in several successive bends. The configuration including two bends and the one including six bends also include a second impact of the flows at the outlet of the device. This second impact involves the flows of emulsions formed initially at the first impact and refined by their passage through the bends.

### LIST OF REFERENCES

[1] C.-X. Zhao, A. P. J. Middelberg. “Two-phase microfluidic flows.” Chemical Engineering Science 66.7 (2011): 1394-1411.
[2] H. Ã. Schubert, R. Engel. “Product and formulation engineering of emulsions.” Chemical Engineering 82: 1137-1143.
[3] T. Nisisako, T. Hatsuzawa. “A microfluidic cross-flowing emulsion generator for producing biphasic droplets and anisotropically shaped polymer particles.” Microfluidics and Nanofluidics 9.2-3 (2009): 427-437.
[4] N. Kiss, H. Pucher J. Wieser S. Scheler H. Jennewein D. Suzzi J. Khinast, G. Brenn. “Formation of O/W emulsions by static mixers for pharmaceutical applications.” Chemical Engineering Science 66: 5084-5094.
[5] Belkadi, A. Étude expérimentale du fractionnement liquide-liquide en micro-canaux pour la production en continu de biodiesels emulsionnés. Ph.D. thesis, SPIGA, University of Nantes, France, 2015.
[6] T. Nisisako, Toshiro Higuchi, Toru Torii. “Droplet formation in a microchannel network.” Lab on a chip 2.1 (2002b): 24-6.
[7] T. Nisisako, T. Higuchi, T. Torii. “Formation of droplets using branch channels in a microfluidic circuit.” Proceedings of the 41st SICE Annual Conference. SICE 2002. vol. 2. 2002a, 957-959.
[8] A. Tamir, S. Sobhi. “A new Two-Impinging-Streams Emulsifier.” AIChE Journal 31.12 (1985): 2089-2092.
[9] Kiljanski, Tomasz. “Preparation of emulsions using impinging streams.” AIChE Journal 50: 1636-1639.
[10] Ait-Mouheb, N. “Caractérisations expérimentale and numérique de l'écoulement and du transfert de matière dans des micromélangeurs.” Ph.D. thesis, University of Nantes, France, 2010.
[11] N. Ait Mouheb, C. Solliec J. Havlica P. Legentilhomme J. Comiti J. Tihon, A. Montillet. “Flow characterization in T-shaped and crossshaped micromixers.” Microfluidics and Nanofluidics 10.6 (2010): 1185-1197.
[12] S. Nedjar, M. Tazerout, A. Montillet. “Synthèse en continu d'emulsions de type «eau dans huile» à l'aide de micromélangeurs.” la Société Française de Génie des Procédés. Poster—13e congrès de la société Française de Génie des Procédés, 2011.
[13] A. Montillet, M. Tazerout, S. Nedjar. “Continuous production of water-in-oil emulsion using micromixers.” Fuel 106: 410-416.
[14] A. Belkadi, A. Montillet J. Bellettre P. Massoli, D. Tarlet. “High-speed w/o emulsification within impinging and cross-flowing minichannels.” Proceedings of the 3rd European Conference on Microfluidics. Heidelberg, Germany, 2012.
[15] Galindo Alvarez, J.-M. Etude de l'inversion de phase catastrophique lors de l'emulsification de produits visqueux. Ph.D. thesis, Nancy, 2008.

1. A device for performing a continuous emulsion of two immiscible fluids, comprising:
at least one first microsystem that includes:
at least two micro-channels for the intake of each fluid into the device, the micro-channels, with respective sections S1 and S2 different from S1, facing each other along a central intake axis A and having an offset, linked to their difference in section,
at least two micro-channels for the output from the device of the emulsion once formed,
an intersection area wherein the intake and output micro-channels intersect, the intersection area being able to generate an interface between the fluids and as such forming a pre-emulsion intended to flow in the output micro-channels until the completion of the forming of the emulsion, and
at least one singularity capable of destabilizing the interfaces between the fluids in the pre-emulsion.

2. The device according to claim 1, wherein the output micro-channels are arranged, in the microsystem symmetrically, with respect to the central intake axis (A).

3. The device as claimed in claim 1, wherein the singularity is a bend formed in each output micro-channel of the microsystem.

4. The device according to claim 3, further comprising two to six bends formed in each output micro-channel of the microsystem.

5. The device according to claim 1, wherein the singularity is an abrupt widening or narrowing formed in each output micro-channel of the microsystem.

6. The device according to claim 1, further comprising a second microsystem in series or in parallel comprising:
at least two micro-channels for the intake into the device of each fluid, facing each other along a central intake axis, and
at least two micro-channels for the output from the device of the emulsion formed.

7. The device according to claim 6, wherein the second microsystem is identical to the first microsystem.

8. The device as claimed in claim 1, wherein the intake and output micro-channels have a square or rectangular section S1, S2.

9. A method for performing a continuous emulsion of two immiscible liquids implementing the device according to claim 1, the method comprising:
1) supplying each fluid in the intake micro-channels of the microsystem,
2) enabling the frontal collision of the fluids at the intersection of the intake and output micro-channels, in such a way as to generate an interface between the two liquids forming a pre-emulsion,
3) enabling the intake of the pre-emulsion into the output channels,
4) enabling the output from the microsystem via the output channels of the finalised emulsion including a continuous phase and a dispersed phase, the flow rate of the fluid of the continuous phase is between 8.3.10⁻⁷ m³/s to 20.10⁻⁷ m³/s, and the fluid of the dispersed phase represents between 3 and 20% by volume of the continuous phase, and
5) splitting the pre-emulsion between the steps 3 and 4, in order to obtain an emulsion with an average diameter of the drops of the dispersed phase between 5 and 20 micrometres.

10. The method according to claim 9, wherein the fluid of the dispersed phase represents between 5 and 10% by volume of the continuous phase.

11. The method according to claim 9, wherein the flow rate of the fluid of the continuous phase is between 8.3.10⁻⁷ m³/s and 12.10⁻⁷ m³/s.

12. The method according to claim 9, wherein the fluids to be emulsified include:
a hydrophilic fluid, preferably an aqueous phase, and
a hydrophobic fluid, preferably a lipid or hydrocarbon fluid.

13. The method according to claim 12, wherein the hydrophilic fluid is a salt-free aqueous phase and the lipid or hydrocarbon fluid is free of surfactant.

14. A method of using the emulsion able to be obtained by the method according to claim 13, as a fuel for internal combustion engines, turbines, furnaces and boilers.

15. The device as claimed in claim 2, wherein the singularity is a bend formed in each output micro-channel of the microsystem.

16. The device according to claim 2, wherein the singularity is an abrupt widening or narrowing formed in each output micro-channel of the microsystem.

17. The device according to claim 2, further comprising a second microsystem in series or in parallel comprising:
at least two micro-channels for the intake into the device of each fluid, facing each other along a central intake axis, and
at least two micro-channels for the output from the device of the emulsion formed.

18. The device as claimed in claim 2, wherein the intake and output micro-channels have a square or rectangular section S1, S2.

19. The device as claimed in claim 3, wherein the intake and output micro-channels have a square or rectangular section S1, S2.

20. The device as claimed in claim 4, wherein the intake and output micro-channels have a square or rectangular section S1, S2.
